(19) United States
(12) Patent Application Publication
(10) Pub. No.: US 2009/0307090 A1
(43) Pub. Date: Dec. 10, 2009

(54) System and Method for Inserting Advertisements in Voicemail

(75) Inventors: Shekhar Gupta, Overlands Park, KS (US); Mike A. Roberts, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/133,694

(22) Filed: Jun. 5, 2008

(51) Int. Cl. G06Q 30/00

(52) U.S. Cl. 705/14.58

(57) ABSTRACT

A method and system for inserting targeted advertisements into voicemail. User demographics, location of the user, and/or keywords within the voicemail may be used to target advertisements to customers, thus providing relevant advertisements within the voicemail to the customers. One embodiment includes receiving a voicemail for delivery to a recipient. One or more keywords received in the voicemail may be identified. An advertisement may be selected in response to the identification of one or more keywords. The selected advertisement may be sent with the voicemail.

### BACKGROUND OF THE INVENTION

Answering machines have been around for many years recording messages for people who were either not at home, too busy, or just did not want to answer a telephone call. Early answering machines recorded messages onto audio tape, which a recipient could play back at a later time. Audio tape-based answering machines gave way to digital answering machines with messages being recorded digitally on a device that was typically located at the call recipient's address. More recently, the days of traditional answering machines appear numbered as voicemail has come to dominate the telephone message recording market.

Voicemail is generally managed and operated by a server, either local or telecommunications network based. In the event of being network based, voicemail is usually operated by a telephone service provider. The recipient of a voicemail is alerted to the presence of the voicemail by a light, distinct dial tone, or some other notification. To retrieve the voicemail, the recipient accesses the message using a telephone, rather than through a local answering machine.

Many service providers charge a monthly fee for providing voice mail service to their customers. Generally, the fee is a flat fee added onto the service provider's customer's monthly bill. For example, voicemail service might cost customers $4.99 per month.

Customers often balk at paying higher service fees. As understood, the more features a customer chooses, the higher his or her monthly bill tends to be. Optional services, such as voicemail, have been a revenue generating source for many service providers. In general, service providers are unwilling to provide optional services for free. Increased pressure from customers for a better value and from competitors have service providers looking for alternative sources of revenue rather than raising rates or providing optional, cost-free features.

### BRIEF SUMMARY OF THE INVENTION

By providing a method and system for inserting targeted advertisements into voicemail, service providers may generate additional revenue from advertisers and reduce costs to an end user. User demographics, location of the user, and/or keywords within the voicemail may be used to target advertisements to customers, thus providing relevant advertisements to the customers.

One embodiment includes a method for inserting advertisements in voicemail. The method includes receiving a voicemail for delivery to a recipient. One or more keywords received in the voicemail may be identified. An advertisement may be selected in response to the identification of one or more keywords. The selected advertisement may be sent with the voicemail.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary environment for inserting a targeted advertisement into a voicemail;

FIG. 2 is a block diagram of exemplary components of a server configured to facilitate inserting targeted advertisement into a voicemail;

FIG. 3 is a block diagram of exemplary modules for inserting targeted advertisements into voicemail; and

FIG. 4 is a flow chart of an exemplary process for inserting targeted advertisements into voicemail in accordance with the principles of the present invention.

### DETAILED DESCRIPTION OF THE INVENTION

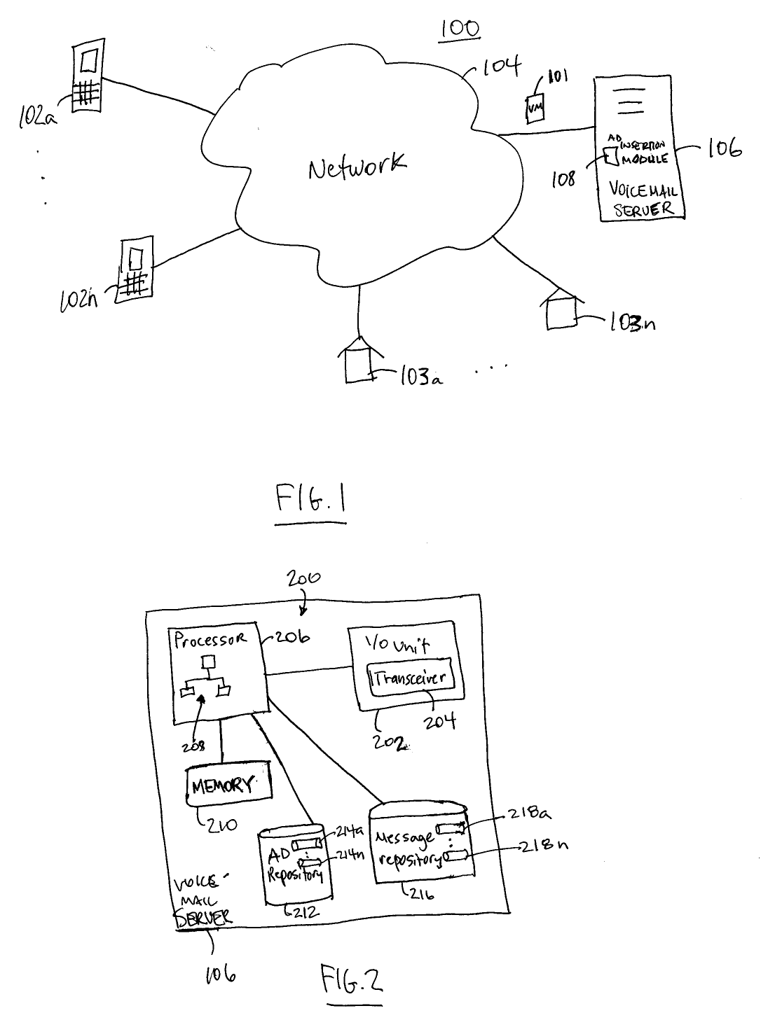

FIG. 1 is an illustration of an exemplary environment 100 for inserting a targeted advertisement into a voicemail message 101. For purposes of the specification, “voicemail” and “voicemail message” may be used interchangeably throughout the specification and are intended to refer to the same thing. By “inserting” an advertisement into a voicemail message, an audio advertisement may be appended prior to, during, or after a voicemail message. The advertisement may be accessed in an advertisement repository or saved in the same repository as the voicemail message. In this embodiment, mobile telephone customers 102a-102n (collectively 102) and home telephone customers 103a-103n (collectively 103) may communicate over a network 104, in which a voicemail server 106 may also be in communication. Within the voicemail server 106 may be an ad insertion module 108 capable of performing the principles of the present invention.

An example of a mobile telephone customer 102 may be a subscriber of a cellular service provider, but may be a subscriber to any type of mobile service capable of receiving a voicemail message 101. Exemplary mobile devices may include a smart phone, personal digital assistant (PDA), traditional mobile telephone, or any other type of mobile electronic device. Home telephone customers 103 may use any type of device for communicating with the network 104. One example of a home telephone is a traditional telephone that connects over a public switched telephone network (PSTN). Other telephone devices may include cordless phones, Voice over Internet Protocol (VOIP) telephone, computer with communication devices such as a microphone and speakers attached (i.e., soft-phone), or any other device configured to communicate with the network 104 and provide voice communication services.

The network 104 may be a PSTN, the Internet, any type of cellular network such as GSM, CDMA, TDMA, and UMTS, or any other type of network operable to communicate with the voicemail server 106 and communicating a voicemail message 101.

The voicemail server 106 may be any server or device configured to process voicemail communications and to communicate a voicemail message 101 over the network 104. For example, if the network is a PSTN, the voicemail server 106 may be located at a central office (CO). In another embodiment, the network may be the Internet and the voicemail server 106 may be anywhere with a connection to the Internet. These are just two examples of many that would be considered in the scope of the invention.

The ad insertion module 108 may be located within the voicemail server 106 and may be configured to control the insertion of audio advertisements into the voicemail message 101. The ad insertion module 108 may include any combination of hardware or software. The ad insertion module 108 is described below in greater detail in FIG. 3.

FIG. 2 is a block diagram of exemplary components 200 of voicemail server 106 of FIG. 1 configured to facilitate inserting a targeted advertisement into a voicemail. The voicemail server 106 may include an input/output (I/O) unit 202 for receiving and communicating a voicemail message. The I/O unit 202 may additionally include a transceiver 204 for transmitting voicemail to a user and for receiving voicemail from the network. The voicemail server 106 may also include a processor 206 for processing the voicemail. The processor 206 may execute software 208 capable of performing the functionality of the voicemail server 106. Software modules that operate in the software 208 are described below in more detail in reference to FIG. 3. Memory 210 may also be located within the voicemail server 106 for storing data being processed by the processor 206. An ad repository 212 may also be included in or be in communication with the voicemail server 106. The ad repository 212 may be a hard drive or any other type of volatile or non-volatile memory capable of storing advertisement data. Within the ad repository 212 may be one or more data repositories 214a-214n, such as a database or multiple databases, capable of storing and organizing data, such as advertisements. In one embodiment, rather than including the ad repository 212, the voicemail server 106 may use a memory 210 that is large enough to store a sufficient number of advertisements.

Similarly, a message repository 216 may also be included in the voicemail server 106. The message repository 216 may be a hard drive or any other type of volatile or non-volatile memory capable of storing voicemail messages. Within the message repository 216 may be one or more data repositories 218a-218n, such as a database, or multiple databases, capable of storing and organizing data, such as voice messages. In one embodiment, rather than including the message repository 216, the voicemail server 106 may use the memory 210 to store the voicemail messages.

FIG. 3 is a block diagram of exemplary modules 300 configured to insert targeted advertisements into voicemail. A targeted advertisement is an advertisement that has some relationship to content (e.g., words) within a voice message. For example, if the word “pizza” is spoken in a voice message, an advertisement for a pizza restaurant may be inserted into the voice message. The modules 300 are exemplary in nature and are not intended to limit the scope of the invention. In one embodiment the modules 300 may be software modules configured to operate on the processor 208 within a voicemail server 106. One module is a voicemail recordation module 302. The voicemail recordation module 302 may provide the functionality necessary for storing a voicemail message received by the voicemail server 106. The voicemail recordation module 302 may control the I/O unit (similar to 202 in FIG. 2) to allocate memory for storing the voicemail, provide the mapping necessary for linking a received voicemail to a recipient, and provide the actual recordation and playback abilities of the voicemail server, among other functions.

Related to the voicemail recordation module 302 is the concept of when a voicemail should be considered to be received. A voicemail may be considered to be received if or when it is recorded by the voicemail server. Alternatively, a voicemail may be considered received by the voicemail server when the voicemail message begins to be processed, in the case of real-time processing for the advertising selection for the voicemail. In the case of real-time processing, the voicemail server may receive a previously recorded voicemail, by the voicemail server or otherwise, and the selection and sending of the advertisement would occur at that time rather than when the voicemail was initially recorded.

The keyword identification module 304 may provide for identification and selection of one or more relevant keywords or topics relating to a voicemail message. Any number of methods may be used for determining or identifying the one or more keywords or topics. A voicemail message may be processed using a voice-to-text or speech recognition type conversion, as understood in the art. If the voicemail speech is converted to text, the text of the voicemail message may then be analyzed. If a particular word is used or if multiple occurrences of the same word occurs, the word or repeated word may be identified as a related keyword. In another embodiment, audio signals of the voicemail and known audio signals of keywords in advertisements may be compared without text conversion. Similar to the speech-to-text conversion method, unique words and repeated words may provide for selection of the keyword for the voicemail.

The selected keyword(s) may be correlated with keywords from the targeted advertisements to identify the most relevant targeted advertisements to associate with the voicemail message. More specifically, the identified keyword or keywords from the keyword identification module 304 may then be used by the ad association module 306 to select an appropriate advertisement for sending with the voicemail. The ad association module 306 may include a table or another software tool that associates keywords or topics with certain advertisements. For example, a table may be set up providing a list of advertisement keywords and topics in one column with a link to or the actual advertisement provided in another column. An example is provided below in TABLE 1.

TABLE 1

| Advertisement | |
|---|---|
| Keywords | Advertisement |
| food, restaurant, | KFC-1, KFC-2, Kroger |
| drinks, meal, pizza, | |
| burger | |
| car, tires, taxi, ride | Honda, Jiffy Lube-1, Jiffy Lube-2 |
| vacation, travel, flight | American Airlines, Expedia, Walt Disney World |
| default | Turbo Tax, Supercuts |

When the identified keyword or keywords are communicated to the ad association module 306, the selection of a targeted advertisement may be made. If a match is made between the identified keyword of a voicemail and the list of advertisement keywords, the related advertisement may be associated with the voicemail, and then sent to the recipient when an ad insertion module 308 is executed. Each keyword may have an associated weighting value to cause different keywords to be more heavily weighted than others (e.g., pizza=4, dinner=3), as different words tend to be more categorically specific than others. Also depicted in TABLE 1 is the concept that more than one advertisement might pertain to the advertisement keywords and advertisements may be from the same or different vendors or companies. In this case, an advertisement may be selected at random or in a queue-type scheme where the selected advertisement is rotated, allowing for the advertisement to be selected equally. If no advertisement keyword is found that is identified to be a relevant match to the identified keyword, a set of default advertisements may be associated with the voicemail message. These types of default advertisements may have a wide audience appeal or may be of the type that would not necessarily benefit by specific targeting.

The ad association module 306 may provide real-time association with the advertisement keyword and the voicemail keyword or may provide the advertisement association at the time that a voicemail is recorded and saved. In the case of the ad association module 306 being executed for a voicemail at the time it is recorded, a method for keeping track of the associated advertisement with the voicemail message may be provided. In an exemplary embodiment, a unique ID number may be associated with each advertisement, and may be stored along with the voicemail message for sending together when the voicemail recipient requests the voicemail message.

In addition to keyword usage, the ad association module 306 may also be configured to associate an advertisement with a voicemail message based on the demographics of the recipient of the voicemail message. Demographics may be very useful when used alone or in combination with an identified keyword for picking the most relevant advertisement for the recipient. Demographic data may already be known for the recipient by a service provider if the recipient is also a customer of the service provider. The demographic information may also be located by the use of the Internet, external databases, or any other type of method. An exemplary demographic repository (not shown) may contain demographic information related to recipients of the voicemail message. Some examples include age, gender, location, marital status, children, or any other demographic information.

One demographic data element that may be used is the location of the recipient. By determining where the recipient is located, advertisements for local advertisers may be provided, allowing for the most relevant advertisements to be selected by keyword, location, or both. Another location that may be associated with the recipient may be a location or destination that is mentioned in the voicemail. An example would be if the voicemail mentions an upcoming trip to Orlando and asks to have dinner one night—not only can a restaurant advertisement be provided, but an advertisement for restaurants specifically with locations in Orlando can be provided.

The ad insertion module 308 may insert the associated advertisement with the voicemail. The associated advertisement may be inserted or provided within the same voicemail message, before the voicemail message, or after the voicemail message. The advertisement may be interactive and provide a way to access additional information to the recipient upon request. For example, after hearing an advertisement for a restaurant, a message may indicate that the user can “press 1 for additional information.” The information may be immediately provided to the recipient or may be provided in a subsequent communication to the recipient. The additional information may be in any form not limited to the telephone, such as an e-mail or postal mail, just to name two examples. In the case of a visual voicemail, where a voicemail is processed using a speech-to-text or other speech conversion technique for visually displaying a voicemail rather than listening to a voicemail, the advertising may appear as a hyperlink that may be selected for displaying the advertisement or the advertisement speech may be translated and depicted as text.

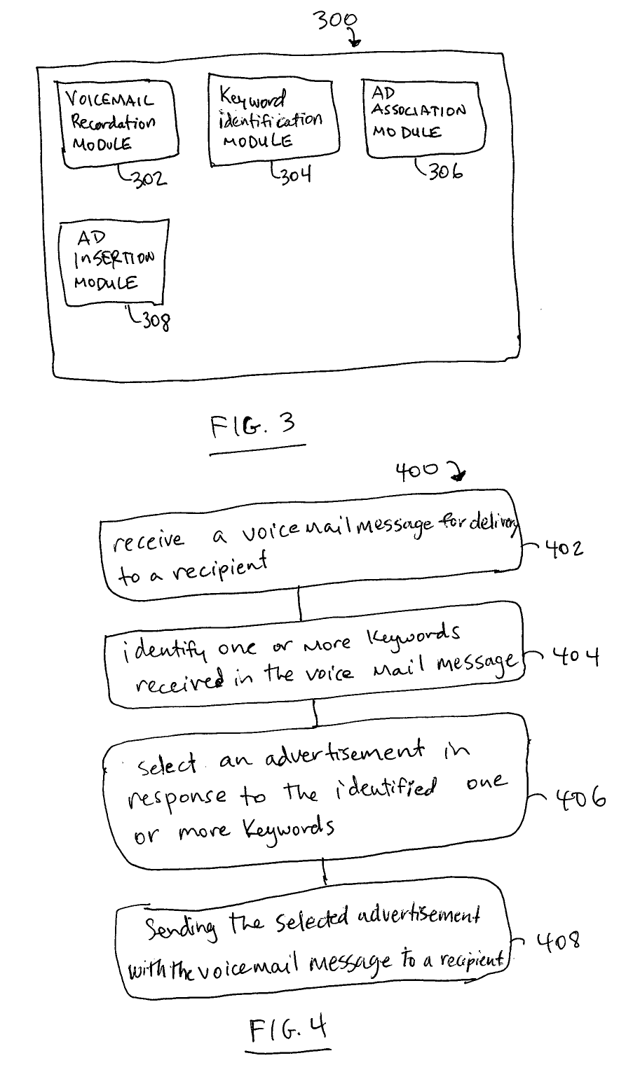

FIG. 4 is a flow chart of an exemplary process 400 for inserting targeted advertisements into voicemail in accordance with the principles of the present invention. In step 402, a voicemail may be received for delivery to a recipient. The voicemail may be received at the time the voicemail is recorded, when the voicemail is being requested by a recipient, or at any other time before the voicemail is delivered to the recipient. In step 404, identification of one or more keywords received in the voicemail message may occur. The one or more keywords may be identified by recognizing unique words, repeated words, or using any number of other techniques to identify words spoken in a voicemail message. In step 406, an advertisement may be selected in response to the identifying one or more keywords. In one embodiment, the selection of the advertisement may be based on a list of categorized advertisements with keywords being associated with the various categories. In addition to the use of the keywords, other criteria may also be used in determining the advertisement selection, such as location of the user or locations mentioned in the voicemail. In step 408, the advertisement is sent with the voicemail. In an exemplary embodiment, the advertisement is sent before the content of the voicemail message to better ensure that a user listens to the advertisement, but the advertisement may be anywhere within the communication, such as after the voicemail, or even may be sent separately as described above.

Although the description is that of voicemail, it should be understood that the same or similar functionality may be provided for video mail in the future, where speech may be analyzed and targeted video advertisements may be displayed.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for playing advertisements in voicemail messages, said method comprising:
receiving a voicemail message for delivery to a recipient;
identifying one or more keywords received in the voicemail message;
selecting an advertisement in response to the identified one or more keywords; and
sending the selected advertisement with the voicemail message to the recipient.

2. The method according to claim 1, further comprising converting the recorded voicemail message to text.

3. The method according to claim 2, wherein determining one or more keywords associated with the voicemail message includes determining the one or more keywords by analyzing the text of the voicemail message.

4. The method according to claim 1, wherein identifying one or more keywords associated with the voicemail message includes comparing audio signals of the voicemail to audio signals of the one or more keywords.

5. The method according to claim 1, further comprising:
accessing demographics of a recipient; and
selecting the advertisement based on the demographics of the recipient.

6. The method according to claim 1, wherein sending the advertisement includes playing an audio advertisement prior to playing the voicemail message.

7. The method according to claim 1, further comprising enabling the recipient to request additional information associated with the advertisement to be delivered to the recipient.

8. The method according to claim 7, further comprising communicating the additional information associated with the advertisement in a subsequent communication.

9. The method according to claim 1, further comprising determining a location associated with the recipient, and wherein the advertisement is based on the determined location and one or more keywords.

10. The method according to claim 9, wherein determining a location associated with the recipient further includes determining a location based on the one or more keywords associated with the voicemail message.

11. A system for playing an advertisement in association with a voicemail message, said system comprising:
a network element configured to:
receive a voicemail message for delivery to a recipient;
process an audio signal of the voicemail;
identify one or more keywords received in the processed audio signal of the voicemail;
select an advertisement in response to the identified one or more keywords; and
send the selected advertisement to the recipient.

12. The system according to claim 11, wherein the network element is further configured to convert the recorded voicemail message to text.

13. The system according to claim 12, wherein the network element is further configured to determine the one or more keywords by analyzing the text of the voicemail message.

14. The system according to claim 11, wherein the network element, in identifying one or more keywords are included in the voicemail message, is further configured to compare audio signals of the recorded voicemail message to audio signals of the keywords.

15. The system according to claim 11, wherein the network element is further configured to analyze demographics of the recipient to select the advertisement.

16. The system according to claim 11, wherein the network element, in inserting the advertisement, is further configured to play an audio advertisement prior to playing the voicemail message.

17. The system according to claim 11, wherein the network element is further configured to enable the user to request additional information associated with the advertisement delivered to the recipient.

18. The system according to claim 17, wherein the network element, in sending to the user additional information associated with the advertisement, delivers the information via an e-mail.

19. The system according to claim 11, wherein the network element is further configured to determine a location associated with the recipient, and wherein the advertisement is selected based on the determined location and the one or more keywords.

20. The system according to claim 19, wherein the network element, in determining a location associated with the recipient, is further configured to determine a location based on the one or more keywords associated with the voicemail message.
